(19) United States
(12) Patent Application Publication
(10) Pub. No.: US 2005/0005755 A1
(43) Pub. Date: Jan. 13, 2005

(54) Method and apparatus for cutting a sheet material

(76) Inventors: Robert R. Turvey, Sanford, MI (US); Marissa A.K. Schultz, Racine, WI (US); John S. Sabol JR., Sanford, MI (US); Kristopher W. Gerulski, Racine, WI (US); Bryan L. Ackerman, Freeland, MI (US); David W. Gustafson, Midland, MI (US); Nancy L. Broen, Racine, WI (US)

Correspondence Address: S.C. JOHNSON & SON, INC., 1525 HOWE STREET, RACINE, WI, 53403-2236, US

(21) Appl. No.: 10/856,048

(22) Filed: May 28, 2004

Related U.S. Application Data
(60) Provisional application No. 60/474,575, filed on May 29, 2003.
(60) Provisional application No. 60/477,507, filed on Jun. 10, 2003.
(60) Provisional application No. 60/503,430, filed on Sep. 16, 2003.

(51) Int. Cl. B26D 1/04

(52) U.S. Cl. 83/614; 83/649

(57) ABSTRACT

A dispenser for sheet material includes a box and a cutting apparatus attached to the box, wherein the cutting apparatus includes a track assembly and a slider assembly disposed on the track assembly for movement therealong. The track assembly includes a base and a rail extending from an outer side of the base and terminating in a portion having an oval cross-sectional shape.

### CROSS REFERENCE TO RELATED APPLICATIONS

This application claims the benefit of U.S. Provisional Application No. 60/474,575, filed May 29, 2003; U.S. Provisional Application No. 60/477,507, filed Jun. 10, 2003; and U.S. Provisional Application No. 60/503,430, filed Sep. 16, 2003.

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present invention relates to dispensers for sheet materials, and more particularly, to dispensers for storing and cutting sheet materials.

2. Description of the Background of the Invention

Sheet materials, such as plastic film, metal film and the like, are usually provided to the customer on a roll in a box. The box generally includes a strip of cutting teeth along an edge thereof. When a user desires to utilize a portion of sheet material, he must find the end of the roll, pull the film outwardly, and place the sheet material across the cutting teeth at a desired cutting location. Thereafter, the user must drag the sheet material across the cutting teeth, thereby cutting the sheet material. This process is tedious and rarely results in a uniform tear line across the sheet material.

Chen U.S. Pat. No. 4,787,284 discloses a cutting apparatus for wrap film. The apparatus includes a sliding saddle mounted in a sliding manner in a guiding track slot of a cardboard dispenser box. The sliding saddle includes a T-shaped upper half portion and an I-shaped lower half portion connected by a mid-prop. The I-shaped lower half portion is mounted on the guiding track slot such that the mid-prop and T-shaped upper half portion extend above the slot. The mid-prop includes a razor on a front portion thereof for cutting wrap film.

Chuang U.S. Pat. No. 4,960,022 discloses a plastic film cutter having a slidable cutting means is. The plastic film cutter includes rollers on a bottom surface thereof, wherein the rollers guide the cutter along a sliding furrow attached to a storage box containing a plastic film roll.

Schuler U.S. Pat. No. 6,105,481 discloses a foil dispenser for slicing and dispensing sections of foil. The dispenser includes a dispensing slot for dispensing foil therefrom and a cutting slot, wherein a cutting blade projects through the cutting slot. The cutting blade is situated on a blade holder, which is movable in a blade holder guide. When the dispenser is sufficiently inclined, the cutting blade moves under gravitational forces along the cutting slot to cut a portion of the foil from the roll.

Chen U.S. Pat. No. 6,223,639 discloses an aluminum foil safety fixture for separating aluminum foil in a safe and convenient cutting process. The fixture includes a supporting plate with a slide rail extending from a top edge of the supporting plate. The fixture further includes a push unit assembled in the slide rail, wherein the push unit includes at least one set of slide pressing rollers that keep the foil in a tense form during separation thereof.

Baker, Jr. U.S. Publication No. 2004/0007606 discloses a cutter for cutting sheet materials. The cutter includes a handle, a stem connected to the handle, a cutting blade, and optionally a hook attached to the stem for attaching the cutter to a box. The box includes a top surface, a front flap attached to the top surface, and a front wall, wherein a slot is formed between the front flap and the front wall. The handle straddles the slot such that the stem is disposed in the slot for guiding the cutter along the slot. If the cutter includes a hook, the hook is hooked around a bottom edge of the front flap to prevent the cutter from being removed from the box.

### SUMMARY OF THE INVENTION

According to one aspect of the present invention, a dispenser for sheet material includes a box and a cutting apparatus attached to the box, wherein the cutting apparatus includes a track assembly and a slider assembly disposed on the track assembly for movement therealong. The track assembly includes a base and a rail extending from an outer side of the base and terminating in a portion having an oval cross-sectional shape.

According to another aspect of the present invention, a dispenser includes a box and a cutting apparatus attached to the box, wherein the cutting apparatus includes a track assembly and a slider assembly disposed on the track assembly for movement therealong. The track assembly includes a base and two support rails extending from an upper side of the base and terminating in circular-shaped portions, wherein the support rails are spaced from and parallel to one another and wherein the slider assembly is disposed between the support rails.

According to yet another aspect of the present invention, a dispenser for sheet material includes a box having an angled corner and a cutting apparatus disposed on the angled corner of the box and including a slider assembly.

Other aspects and advantages of the present invention will become apparent upon consideration of the following detailed description.

### BRIEF DESCRIPTION OF THE DRAWINGS

FIG. 1 is an isometric view of a dispenser according to a first embodiment;

FIG. 2 is a sectional view taken generally along the lines 2-2 of FIG. 1;

FIG. 2a is an enlarged fragmentary view of FIG. 2 of an alternative slider and end stop design;

FIG. 2b is a sectional view taken generally along the line 2b-2b of FIG. 2a;

FIG. 2c is an isometric view of the dispenser of FIG. 1 utilizing an alternative box and end stop design;

FIG. 3 is an isometric view of a dispenser according to a second embodiment;

FIG. 3a is an enlarged fragmentary end view of the box and track assembly of FIG. 3;

FIG. 4 is an enlarged fragmentary isometric view of a slider in a storage orientation according to the embodiment of FIG. 3;

FIG. 5 is an enlarged fragmentary isometric view of a slider in a cutting orientation according to the embodiment of FIG. 3;

FIG. 6 is an elevation front view of an alternative slider for use with the embodiment of FIG. 3;

FIG. 7 is a sectional view taken generally along the line 7-7 of the slider of FIG. 6;

FIG. 8 is an isometric view of the slider of FIG. 6;

FIG. 9 is an enlarged end view of a cutting apparatus according to a third embodiment;

FIG. 10 is an enlarged end view of a cutting apparatus according to a fourth embodiment;

FIG. 11 is a side elevational view of the cutting apparatus of FIG. 10 taken along the line 11-11;

FIG. 12 is sectional view taken generally along the line 12-12 of FIG. 10;

FIG. 13 is an enlarged end view of a cutting apparatus according to a fifth embodiment;

FIG. 14 is a fragmentary side elevational view of the track assembly of FIG. 13;

FIG. 15 is a sectional view taken generally along the line 15-15 of FIG. 13;

FIG. 16 is an isometric view of a dispenser according to a sixth embodiment;

FIG. 17 is a sectional view taken generally along the line 17-17 of FIG. 16;

FIG. 18 is a plan view of flat box blank according to a further embodiment;

FIG. 19 is a view similar to FIG. 18 illustrating a first step in the erection of the blank;

FIG. 20 is an isometric view illustrating a second step in the erection of the blank of FIG. 18;

FIG. 21 is a plan view of the blank of FIG. 20;

FIG. 22 is a side elevational view of the blank of FIG. 20;

FIG. 23 is an isometric view illustrating a third step in the erection of the blank of FIG. 18;

FIG. 24 is a plan view of the blank of FIG. 23;

FIG. 25 is a side elevational view of the blank of FIG. 23;

FIG. 26 is an isometric view illustrating a fourth step in the erection of the blank of FIG. 18;

FIG. 27 is a plan view of the blank of FIG. 26;

FIG. 28 is a side elevational view of the blank of FIG. 26;

FIG. 29 is an isometric view illustrating a fifth step in the erection of the blank of FIG. 18 to form the box;

FIG. 30 is a plan view of the box of FIG. 29;

FIG. 31 is a side elevational view of the box of FIG. 29;

FIG. 32 is a front elevational view of the cutter used with the box of FIG. 29;

FIG. 33 is a side elevational view of the cutter of FIG. 32;

FIG. 34 is a plan view of the cutter of FIG. 32;

FIG. 35 is a sectional view of the cutter taken generally along the lines 35-35 of FIG. 32;

FIG. 36 is a front elevational view of the cutter illustrating folding of a gripping portion thereof during shipping of the box; and

FIG. 37-39 are isometric views of a box and assembly apparatus.

### DETAILED DESCRIPTION OF THE PREFERRED EMBODIMENTS

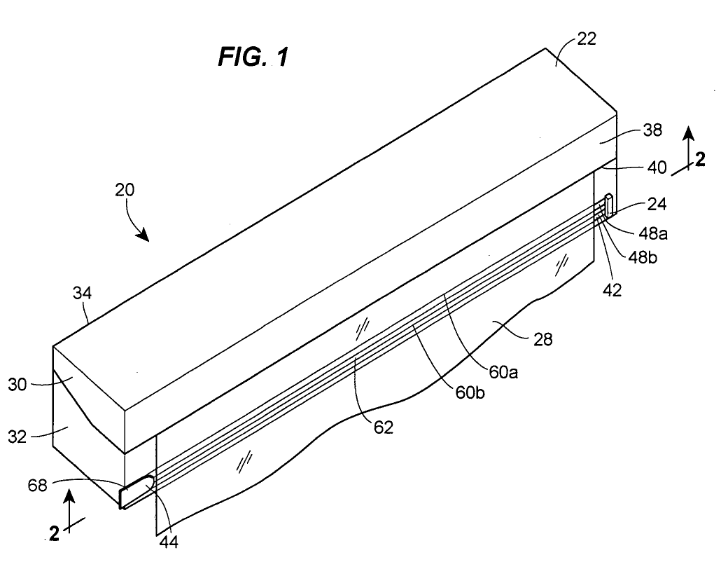

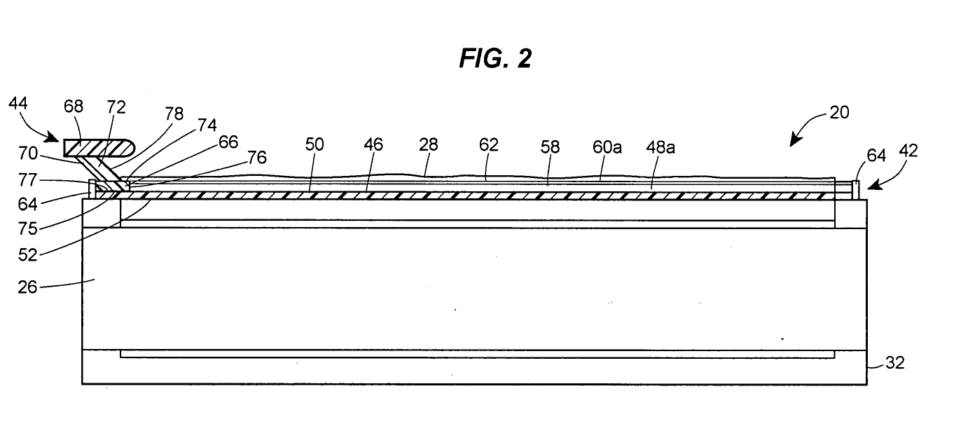

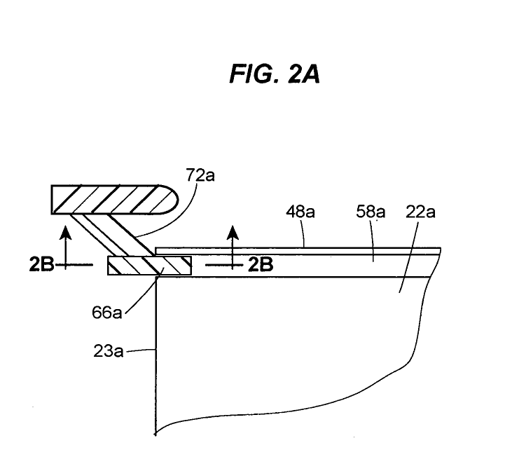

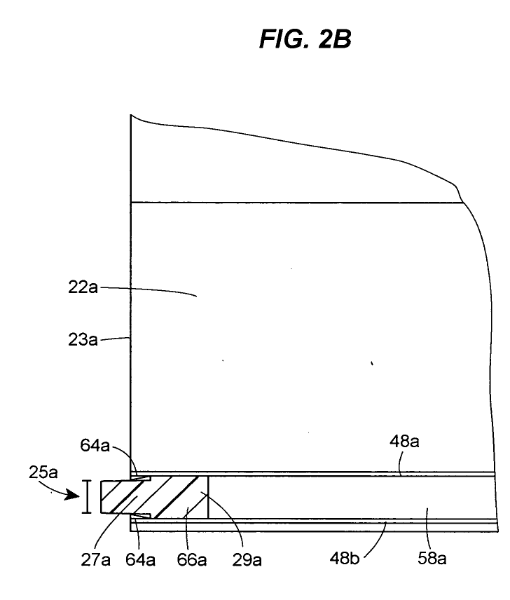

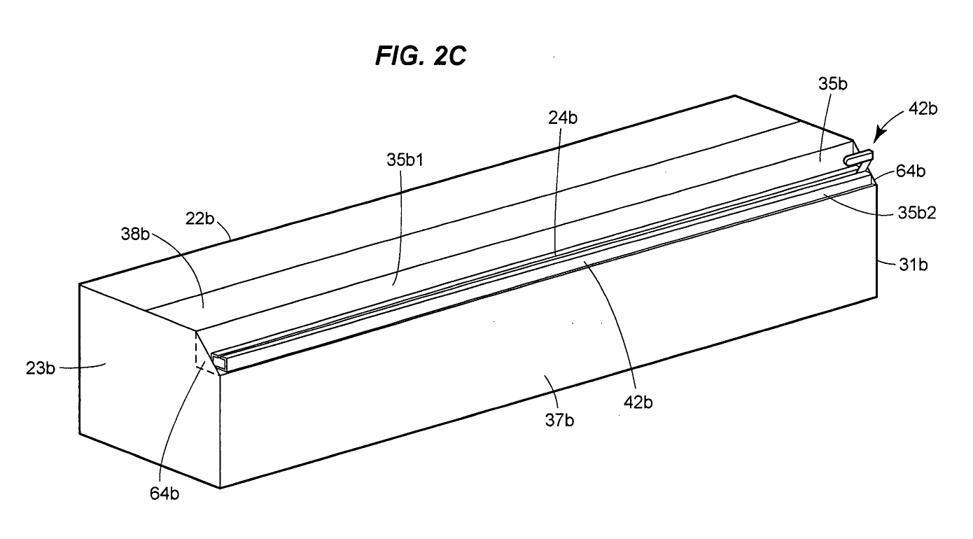

An embodiment of a dispenser 20 is seen in FIGS. 1 and 2. The dispenser 20 comprises a box 22, and a cutting apparatus 24. A roll 26 of a thin sheet material, such as for example, a thermoplastic film 28, may be included in the box. The box 22 comprises an integrated lid section 30 and a container section 32. A fold line 34 is formed in the back side (not shown) of the box 22 to act as a hinge enabling the opening and closing of the lid section 30 with respect to the container section 32. A front side 38 of the box includes an opening or mouth 40 formed between the edge of the lid section 30 and the edge of the container section 32. The box 22 further includes a bottom side 37 of the container section 32 opposite the top of the lid section 30. It should be noted that while a specific example of a box has been described, the use of other types of boxes adapted to dispense sheet material may also be used without departing from the spirit of the invention.

The roll 26 of sheet material, such as for example, thermoplastic film 28, is mounted in the container section 32 of box 22 using any method known in the art so that the film 28 is disposed within the box in a manner that the film 28 can exit the mouth 40 of the box as a thin flat sheet. Alternatively, the roll 26 may be loose (i.e. not journaled or otherwise restrained) within the container section 32.

The cutting apparatus 24 is preferably attached to the box 22 on the front side 38. Alternatively, however, the cutting apparatus 24 can be attached to any side. The cutting apparatus 24 can be attached to the box 22 in any manner known in the art, for example, using a double-sided tape or other adhesive (not shown). The cutting apparatus further comprises a track assembly 42 and a slider assembly 44. Preferably, the track assembly 42 and slider assembly 44 are made of extruded or molded thermoplastic materials, although other materials could be used.

The track assembly 42 typically runs along the length of the box 22 and is substantially the same length as the box mouth 40. However, the use of track assemblies having lengths shorter or longer than that of the box mouth 40 may instead be utilized. The track assembly 42 includes a track base 46 having a first side 50 and a second side 52. A pair of opposing inverted L-shaped rails 48a, 48b extend upwardly from each side of the first side 50 and then inwardly toward the center of the track base 46. The rails 48a, 48b span the entire length of the track base 46. The rails 48a, 48b and the track base 46 define the boundaries of a channel 58. Terminating ends 60a, 60b of the rails 48a, 48b define a slot 62 therebetween. The opening defined by the slot 62 is relatively narrower than the width of the channel 58 between the rails 48a, 48b. An end stop 64 is disposed at each end of the track assembly 42 and prevents the slider assembly 44 from exiting off the ends of the track assembly 42.

The slider assembly 44 comprises a base 66, a head 68, a neck 70 and a blade 72. The base 66 is formed to fit within the dimensions of the channel 58 and has a top side 74 and a bottom side 75 along with a front end 76 and a back end 77. The bottom side 75 comes in contact with the first side 50 of the track base 46. The neck 70 extends from the back end 77 of the top side 74 and is of dimensions and shape to pass through the slot 62. The blade 72 extends from the neck 70 toward the front end 76 of the base and presents a sharpened leading edge 78 on the side of the blade opposite the neck 70. Preferably, the neck 70 extends from the base 66 at approximately a 45 degree angle in relation to the top side 74. However other embodiments, including those where the neck 70 slants away from the back end 77 of the base at angles other than 45 degrees, are also considered to be within the scope of the invention. The head 68 of the slider assembly 44 extends from the neck and provides a gripping surface for a user to slide the entire slider assembly 44 down the track assembly 42 and cut the film 28.

An alternative end stop 64a and slider base 66a arrangement is shown in FIGS. 2a and 2b. The box 22a includes a first end side 23a. In this design the blade 72a is capable of being slid completely beyond the first end side 23a of the box 22a. The end stops 64a are indentations into the channel 58a which extend from the rails 48a, 48b and define an exit width 25a. The slider base 66a includes a first segment 27a and a second segment 29a. The first segment 27a is of shape and dimension capable of fitting through the exit width 25a and the second segment 29a is of shape and dimension capable of fitting through the channel 58a but not the exit width 25a.

Another alternative end stop 64b and box 22b arrangement is shown in FIG. 2c. The track assembly 42b is identical to the track assembly 42 described in relation to FIGS. 1 and 2 with the exception of the end stops 64. The box 22b includes a cut out corner 35b which comprises a vertical shelf 35b1 and a horizontal shelf 35b2 along with a first end side 23b and a second end side 31b. The cutting assembly 24b is disposed on the horizontal shelf 35b2. At each end side 23b and 31b of the cut out corner 35b the box 22b includes an end stop 64b integral with the box 22b and extending from the corner of the front side 38b of the box 22b and the vertical shelf 35b1 to the corner of the bottom side 37b of the box 22b and the horizontal shelf 35b2. In use, when the slider assembly 44b reaches either end of the track assembly 42b the slider assembly 44b comes in contact with an end stop 64a and cannot exit the track assembly 42b.

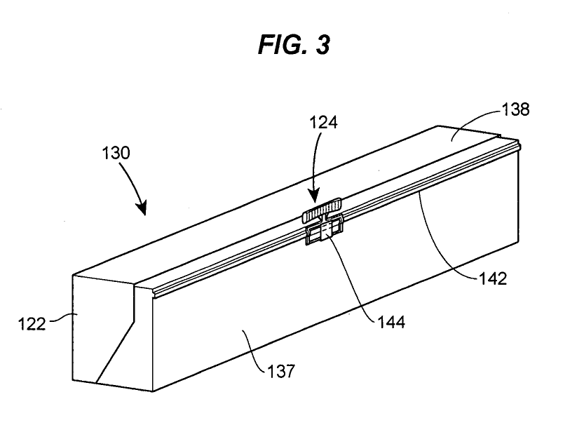

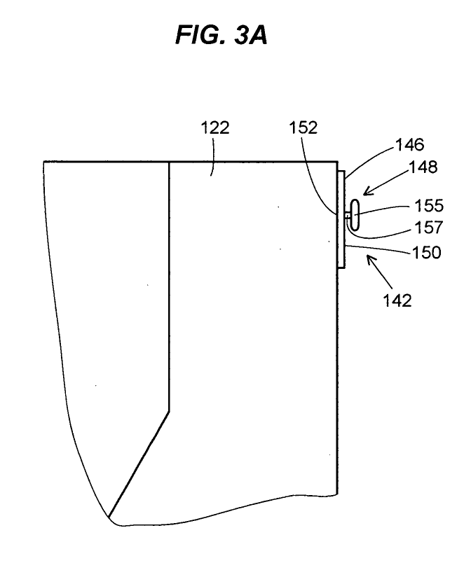

Another embodiment of a dispenser 130 is depicted in FIGS. 3-5. The dispenser includes a box 122 and a cutting apparatus 124. The box 122 is similar in design to the box 22 shown in FIGS. 1 and 2. The cutting apparatus 124 is preferably disposed on the bottom side 137 of the box 122 at or near the edge of a corner formed by the bottom side 137 and the front side 138 of the box 122. However, the cutting apparatus 124 may be disposed along any other edge surface of the box 122.

The cutting apparatus 124 includes a track assembly 142 and a slider assembly 144. The track assembly 142 includes a track base 146 and a rail 148. The track base 146 includes a first side 150 and a second side 152. The second side 152 is attached to the box as described above. The rail 148 extends outwardly from the first side 150 and preferably comprises an oval shaped top portion 155 integral with a support rail 157 connecting the oval shaped top portion 155 with the track base 146. It should however be noted that alternative shaped top portions may be used without departing from the spirit of the invention.

The slider assembly 144 includes a base 166, a body 167, a head 168, a neck 170, and blades 172a, 172b. The base 166 includes a first end 179a and a second end 180 along with a top surface 166a and bottom surface (not shown). A slot 283 on the bottom surface of the base 166 leads into a generally oval shaped cavity 282 at the first end 180 of the base 166 (as shown in FIG. 7). The combination of the oval shaped cavity 282 and slot 283 are formed to complement the shape of the oval shaped top portion 155 and support rail 157 to facilitate the gliding action of the slider assembly 144 with respect to the track assembly 142.

Preferably, the body 167, the neck 170 and the head 168 are integral and comprise a pivotable slider component 153. The body 167 of the slider assembly 144 includes a pivot rod 184, a connecting beam 188 and two substantially similar leg portions 186a, 186b. The connecting beam 188 is generally parallel to the pivot rod 184 and the leg portions 186a, 186b are generally parallel with respect to each other. Each leg portion 186a, 186b includes an arch 141a, 141b of dimension and shape that is adapted to fit over the rail 148. Each of the leg portions 186a, 186b includes a first end and a second end. The pivot rod 184 is disposed between and integral with a first end of each of the leg portions 186a, 186b. The connecting beam 188 is disposed between and integral with the second ends of each of the leg portions 186a, 168b.

The neck 170 extends from approximately a middle section of the connecting beam 188 in a direction opposite that of the leg portions 186a, 186b. The neck 170 generally extends into the head 168. The head 168 includes a first end and a second end. Preferably, although not necessarily, the length of the head 168 between the first and second ends generally approximates the length of the connecting beam 188.

The head 168 includes a first side and a second side opposite the first side. Preferably, although not necessarily, each of the first and second sides has a generally concave shape such that it is generally thinner in the middle section adjacent the neck 170 and relatively thicker at the first and second ends. The user typically grasps the head 168 at its thinner middle section during the cutting process. The blades 172a, 172b are preferably molded into the neck 170 and head 168 to present a leading edge 178a, 178b that is preferably disposed at approximately a 45 degree angle with respect to the neck 170 and the inner surface of the head 168 adjacent the neck 170. Alternatively other blade angle, or designs such as a unitary blade design may be utilized without departing from the spirit of the invention.

When the rail 148 is disposed within the base 166, the first end 179 of the slider base 166 preferably extends to the edge of the track base 146 proximate the edge of the box 122 between the front side 138 and bottom side 137. The second end 180 of the base 166 preferably extends past the edge of the track base 146 opposite the first end 179.

The pivotable slider component 153, is angularly and linearly displaceable with respect to the slider base 166, the track rail 148 and the box 122. The slider base 166 is moveable along a first path between first and second travel limits along the track rail 148. The pivotable slider component 153 is moveable along a second path between third and fourth travel limits with respect to the slider base 166. Preferably, although not necessarily, the first and second paths are substantially parallel.

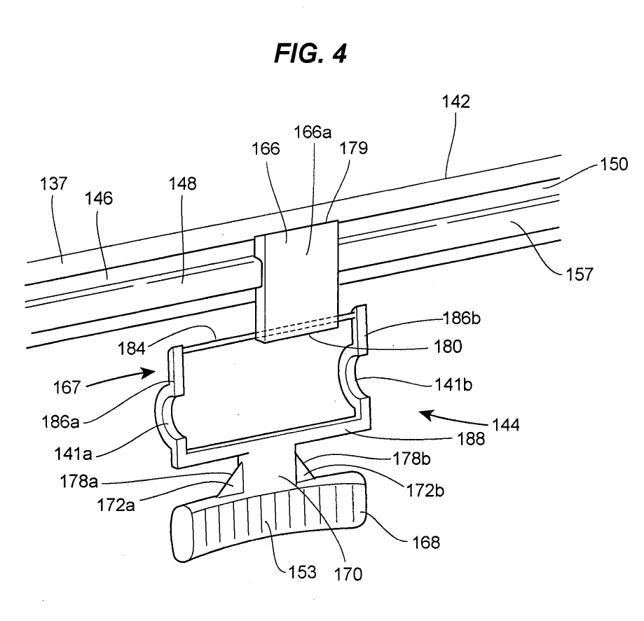

The pivotable slider component 153 is rotatable about a pivot defined by the pivot rod 184 relative to the slider base 166 between a storage orientation and a cutting orientation. When pivotable slider component 153 is in the storage orientation, as seen in FIG. 4, the slider head 168 is disposed below the pivot rod 184 and the slider base 166. The slider assembly 144 is typically positioned in this storage orientation during storage and shipping. In the storage orientation, slider body 167 is rotated away from the track rail 148 and the slider head 168 does not protrude above the edge of the bottom side 137 with the front side 138.

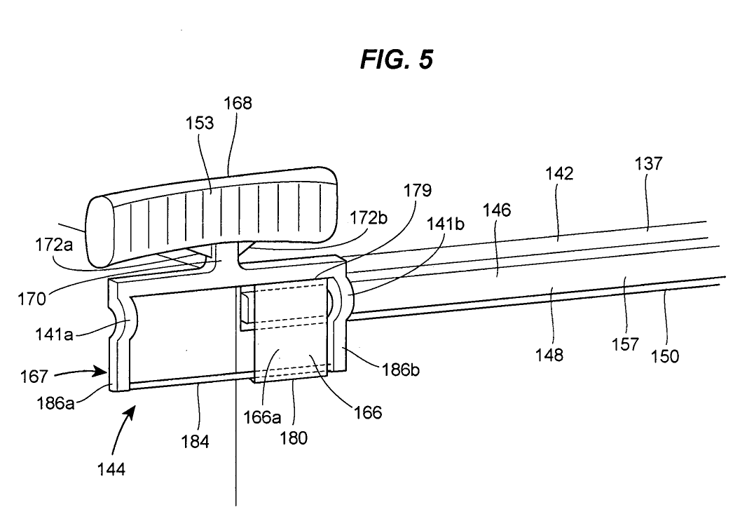

When the pivotable slider component 153 is placed in the cutting orientation, as seen in FIG. 5, the slider head 168 and the blades 172a, 172b are disposed above the slider base 166, thereby rending the slider assembly 144 capable of cutting sheet material dispensed from the box 122. Preferably, the base of the slider 166 and the pivotable slider component 153 are of shape and dimension so that there is an interference fit between the first end 179 of the base 166 and the beam 166 of the pivotable slider component 153 thereby “locking” the pivotable slider component into the cutting orientation.

FIG. 5 also illustrates the slider assembly 144 disposed at the first travel limit along the track rail 148. The pivotable slider component 153 is disposed at the third travel limit with respect to the slider base 166. In this position, the slider assembly 144 would not interfere with the process of withdrawing a section of the sheet material 128 from the box 122 through the box mouth or opening, 140 especially in those instances when the length of the sheet material 128 approaches the length of the box 122.

In operation, the pivotable slider component 153 is disposed in a cutting orientation with the neck 170, head 168 and blades 172a, 172b disposed above the slider base 166. The slider assembly 144 is typically moved to one of the first and second travel limits with the pivotable slider component 153 disposed at one of the third or fourth travel limits with respect to the slider base 166 to permit the sheet material 128 to be dispensed through the mouth or box opening 140 without any interference from the position of the slider assembly 144. Once the sheet material 128 is disposed across the track assembly 142, the user typically grasps the slider head 168 and guides the pivotable slider component 153 to the other of the third and fourth travel limits with respect to the slider base 166 and them moves the slider assembly 144 towards the other of the first and second travel limits thereby cutting through the dispensed sheet material 128. It should be noted while one method of operating the cutting apparatus has been disclosed, alternative methods varying the cutting operation are also considered to be within the scope of the invention.

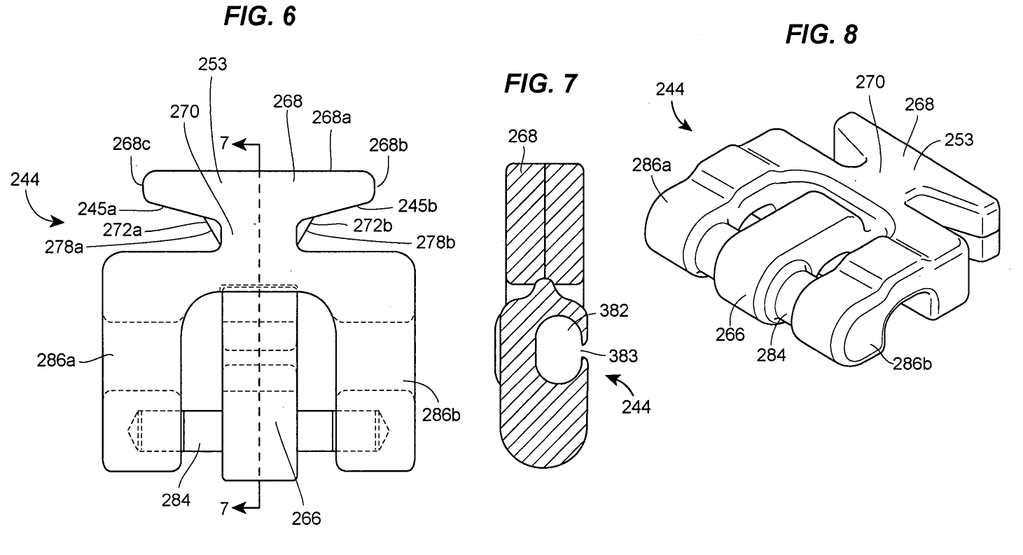

Referring now to FIGS. 6-8 an alternative embodiment of a slider assembly 244 is shown. The slider assembly 244 design is similar in many ways to the slider assembly 144 design described above, with a number of key differences. The slider assembly 244 includes a slider base 266, and a pivotable slider component 253 comprising a body 267, a head 268 and a neck 270. The slider body 267 includes a pivot rod 284 is substantially shorter in length than the pivot rod 184 described in the previous embodiment. The pivot slidable component 253 is rotatable about the pivot rod 284 relative to the slider base 266 between a storage orientation and a cutting orientation. The pivotable slider component 253 is moveable between first and second travel limits with respect to the slider base 266.

The slider head 268 has a generally flat upper surface 268a and first and second flat opposing sides 268b, 268c. Each of a pair of opposing and upwardly slanting sides 245a, 245b are generally disposed between the flat opposing sides 268b, 268c. The upwardly slanting sides 245a, 245b rise from the slider neck 270 to the distal ends of the slider head 268, thereby facilitating contact between the sheet material 28 and the leading edges 278a, 278b of the blades 272a, 272b.

An alternative embodiment of the slider assembly 244 may include one or more protrusions (not shown) from the base 266 extending around the bar 284 and contacting the leg portions 286a, 286b. While this construction does not permit the movement of the pivotable slider component 253 with respect to the slider base 266 the pivotable slider component 253 remains rotatable about a pivot rod between a storage and a cutting orientation.

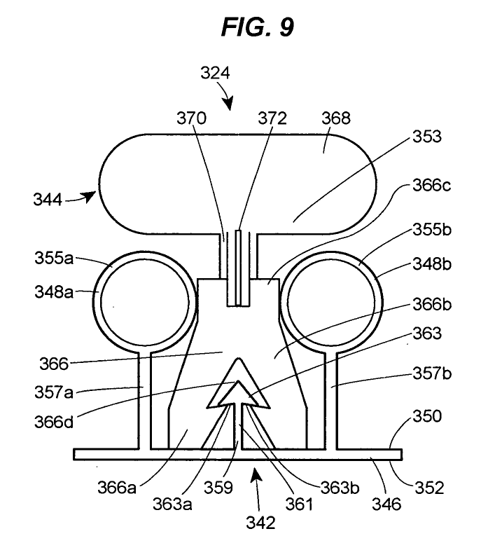

Referring to FIG. 9, another embodiment of a cutting apparatus 324 is shown. The cutting apparatus 324 includes a track assembly 342 and a slider assembly 344. The track assembly 342 includes a track base 346 having a first surface 350 and second surface 353. First and second primary rails 348a. 348b extend from opposing ends of the first surface 350 of the track base 346. Each of the first and second primary rails 348a, 348b include a support rail 357a, 357b extending upwardly from the track base 246 and terminating in preferably, although not necessarily, circular top portion 355a, 355b. The first and second primary rails 348a, 348b are in a spaced apart relationship to each other and run parallel down the entire length of the track base 346. The track assembly 342 may further include an optional retaining rail 359 extending upwardly from the first surface 350 of the track base 346 and disposed between the first and second primary rails 348a, 348b. The retaining rail 359 includes an extension rail 361 that extends from the track base 346 and a retaining portion 363 that is preferably, although not necessarily, in the shape of an arrow pointing upward and away from the first surface 350 of the track base 346. The arrow shaped retaining portion 363 includes lower edges 363a, 363b. While an arrow shaped retaining portion has been described, alternative retaining portion shapes including lower edges 363a, 363b may be utilized.

The slider assembly 344 includes a slider base 366, and a slider component 353, comprising a head 368, a neck 370, and a blade 372. The slider base 366 cooperates with the primary rails 348a, 348b and the retaining rail 359 to maintain the slider assembly 344 within the boundaries defined by the first and second primary rails 348a, 348b as the slider assembly 344 is guided along the length of the cutting apparatus 324.

The slider base 366 includes a bottom portion 366a that is adapted to contact the first surface 350 of the track base 346. The slider base 366 includes a generally arrow shaped notch 366d. The dimension and shape of the arrow shaped notch 366d is designed to cooperate with the arrow shaped retaining rail 359 to maintain the sliding assembly 344 between the first and second primary rails 348a, 348b during the cutting process.

The slider base generally includes a bottom portion 366a, a middle portion 366b, and a top portion 366c. The width of the bottom portion 366a extending between the support rails 357a, 357b is generally greater than the distance between the circular top portions 355a, 355b of the primary rails 348a, 348b. The middle portion 366b extends upwardly and narrows inwardly terminating in an upper end having a width that is less than the distance between the circular top portions 355a, 355b of the primary rails 348a, 348b. The top portion 366c of the base 366 preferably does not extend beyond the tops of the circular top portions 355a, 355b of the primary rails, 348a, 348b. The top portion 366c has a width that is comparable to the width of the upper end of the middle portion 366b and is adapted to fit between the circular top portions 355a, 355b of the primary rails 348a, 348b. The slider assembly 344 may include a neck 370, a blade 372 and a head 368 arranged in any manner previously discussed or any modification thereof.

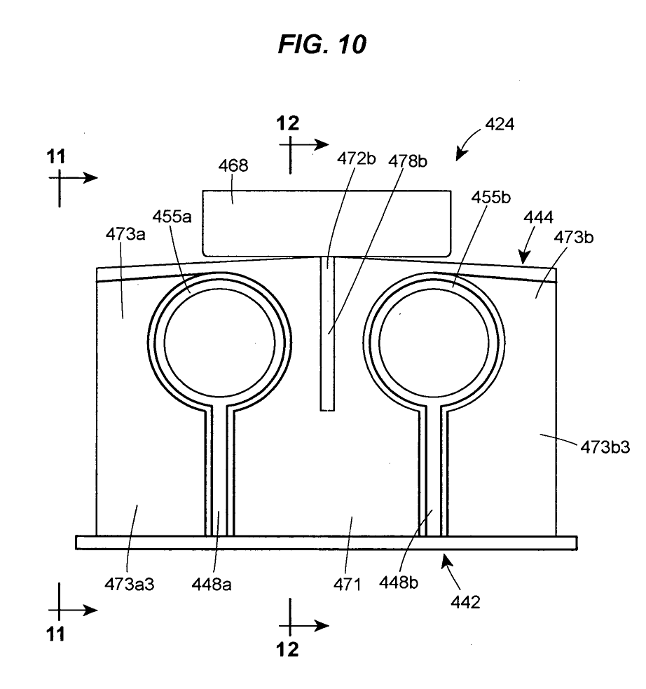

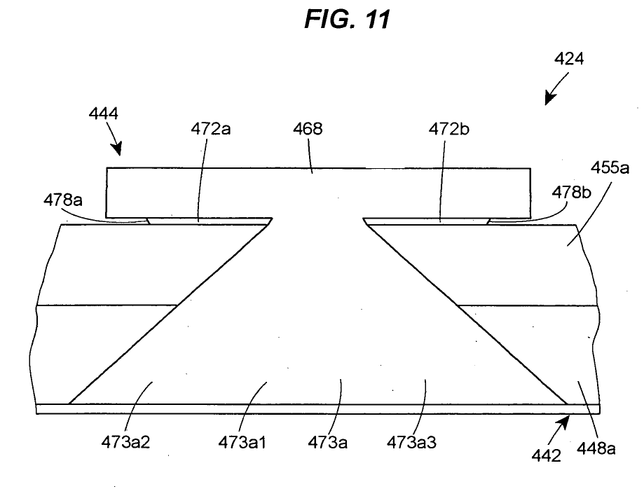

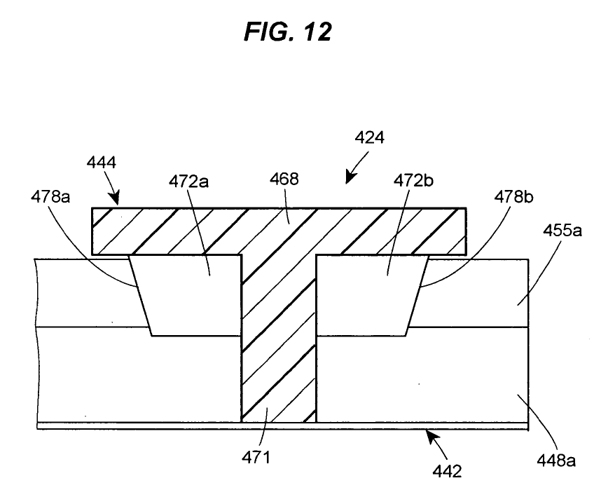

Referring now to FIGS. 10-12, another embodiment of a cutting apparatus 424 is shown. The cutting apparatus 424 includes a track assembly 442 and a slider assembly 444. The track assembly 442 is similar to the track assembly 342 shown in FIG. 9 without the retaining rail 359. More specifically, the track assembly 442 includes a track base 446 having a first surface 450 and a second surface 452. First and second primary rails 448a. 448b extend from opposing ends of the first surface 350 of the track base 446. Each of the first and second primary rails 448a, 448b include a support rail 457a, 457b extending upwardly from the track base 446 and terminating in preferably, although not necessarily, circular top portion 455a, 455b. The first and second primary rails 448a, 448b are in a spaced apart relationship to each other and run parallel down the entire length of the track base 446.

Unlike previously described embodiments, in this embodiment, portions of the slider base 466 extend beyond the outer boundary defined by first and second primary the rails 448a, 448b. The slider assembly 444 comprises a base 466 having an inner portion 471 and identical opposing outer portions 473a, 473b. The inner portion 471 is of shape and dimension so that it fills the space between and extends halfway over the circular top portions 455a, 455b of the rails, 448a, 448b. The outer portions 473a, 473b each base 466 comprise a center portion 473a1, 473b1 (not shown) and two support portions 473a2, 473a3, 473b2 (not shown), 473b3. The center portions 473a1, 473b1 are mirror images of the inner portions 471 so that the rails, 448a, 448b are completely encircled by the slider assembly 444. The support portions 473a2, 473a3, 473b2, 473b3 extend downwardly from the top of the circular top portions 455a, 455b of the rails 448a, 448b to the track base 446 on the outside of the rails, 448a, 448b. The downsloping of the rails allows the film 28 to be lifted up to the blades 472a, 472b and keeps the film 28 from bunching or “plowing” at the front of the slider assembly 444.

The slider assembly also includes blades 472a, 472b that are mounted in the base 466 and extend between and parallel to, the rails, 448a, 448b. Preferably, the leading edges 478a, 478b of the blades 472s, 472b are angled upwardly toward the head 468. However, as in any of the designs disclosed the leading edge blade angle can vary. The head 468 can be of any shape disclosed above or any variation thereof and extends upwardly from the base 466. Preferably, the head 468 is of shape and dimension that is longer than the blades, 472a, 472b to improve safety.

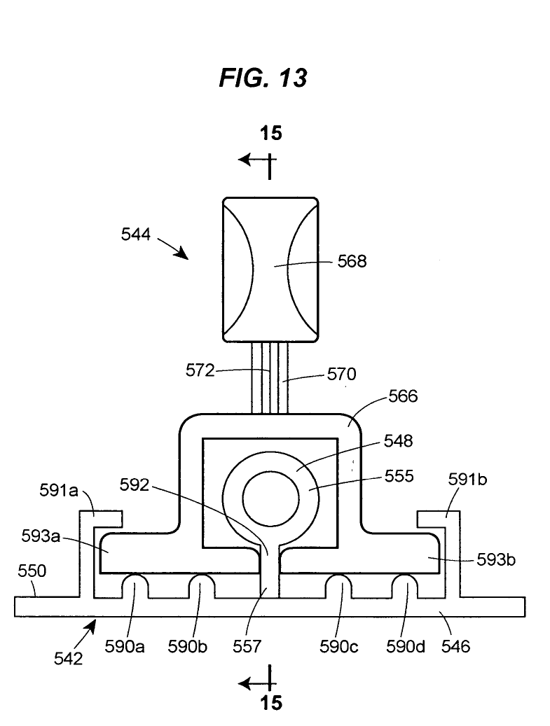

Yet another embodiment of a cutting apparatus 524 is shown in FIGS. 13-15. The track assembly 542 includes a single rail 548 identical to one of the rails 448a, 448b described in relation to FIG. 10. The track base 546 also includes optional ribs 590a, 590b, 590c, 590d extending from the first side 550 of the track base 546, preferably two ribs on each side of the rail 548 in a spaced a part relationship to the rail 548 and to each other. The ribs extend the length of the track assembly 542 and serve to reduce friction between the slider assembly 544 and the track assembly 546. The base may also include inverted L shaped retaining lips 591a, 591b located outside the ribs 590 and extending from the first side 550 of the track base 546.

The slider assembly 544 comprises a base 566, a head 568, a neck 570 and a blade 572. The base 566 defines a box shape with a slot 592 is defined in the middle of one side of the box shape. The slot 592 is disposed to fit the support rail 557 of the rail 548. Support members 593a, 593b extend away from the rail 548 on the bottom edge of the box shaped base 566 to come into an interference fit with the retaining lips 591a, 591b. The neck 570, blade, 572 and head 568 preferably are arranged identically to the arrangement described in relation to FIGS. 1 and 2, although other configurations could be utilized.

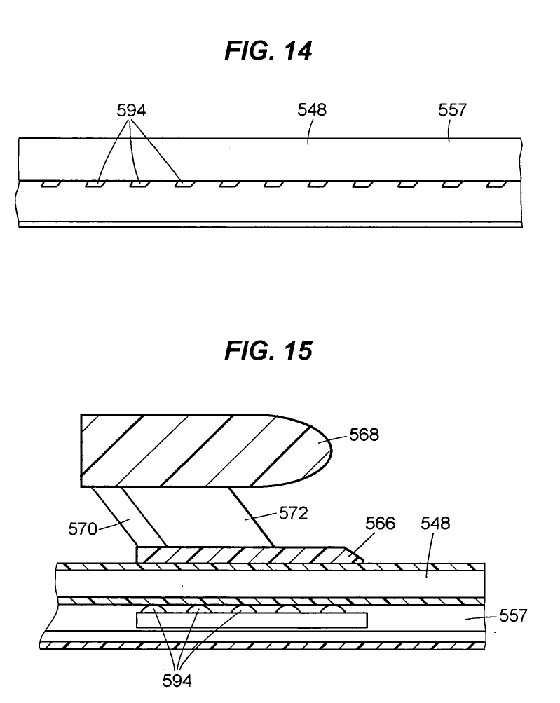

Optionally, the cutting apparatus 524 might include one or more sets of deformations 594 to induce a tactile feel, such as a clicking feel, into the operation of the slider assembly 544. In one example, shown in FIG. 14, the deformations 594 are on the underside of the circular top portion 555 of the rail 548 where the support rail 557 and the circular top portion 555 are connected. In another example, shown in FIG. 15, the deformations 594 are located are disposed in the inner surface of the box shaped base 566 of the slider assembly 544 adjacent the slot 592. Preferably, however the cutting apparatus 524 would utilize two matching sets of deformations 594 in order to give the most feel. Alternatively, the deformations 594 could be located anywhere there is contact between the slider assembly 544 and the track assembly 542, or in a different design, contact between the slider assembly 544 and the box 522.

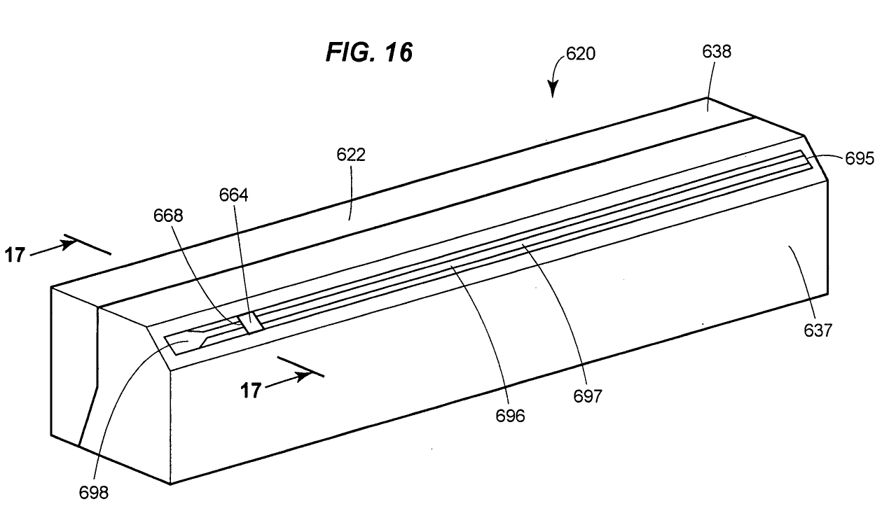

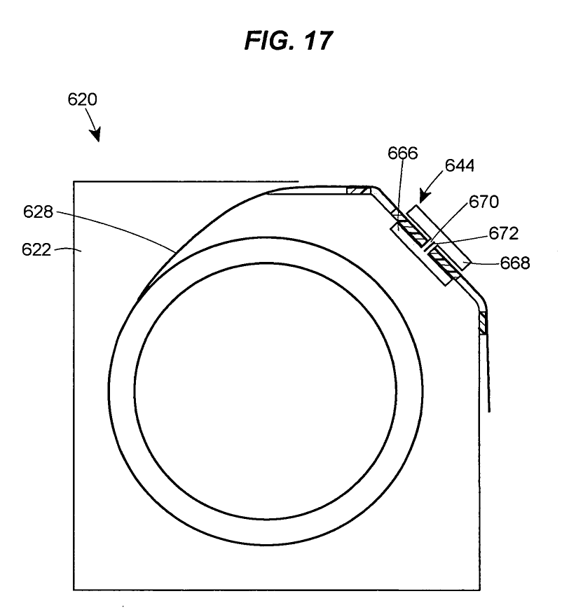

A final embodiment of a dispenser 620 is seen in FIGS. 16 and 17. The dispenser 620 includes a box 622 and a slider assembly 644. The box 622 is identical to the boxes described above with the exception of an angled corner 695 where the front side 638 connects to the bottom side 637. Alternatively the angled corner 695 could be any of the corners of the box 622. The angled corner 695 presents an additional flat surface onto which a die cut 696 is made into the box structure across substantially the entire length of the corner 695, which is preferably made of paperboard. The die cut 696 consists of a narrow slot 697 and a wider entrance hole 698. The entrance hole 698 is preferably located at one end of the die cut 696.

The slider assembly 644 comprises a base 666, a neck 670, a blade 672, and a head 668. The slider assembly is generally in the shape of an I with the base 666 being the bottom of the I, the neck 670 and blade 672, similar to any description above, being the middle of the I, and the head 668 being the top of the I. The base 666 is of shape and dimension that is will pass through the entrance hole 698 but cannot pass through the slot 697. Therefore the slider assembly 644 can only be inserted into entrance hole 698 and cannot be removed during the movement of the slider assembly 644 across the length of the die cut 696. Optionally, the area around the die cut 696 may be reinforced with a plastic reinforcement 699 modeling the shape of the die cut 696.

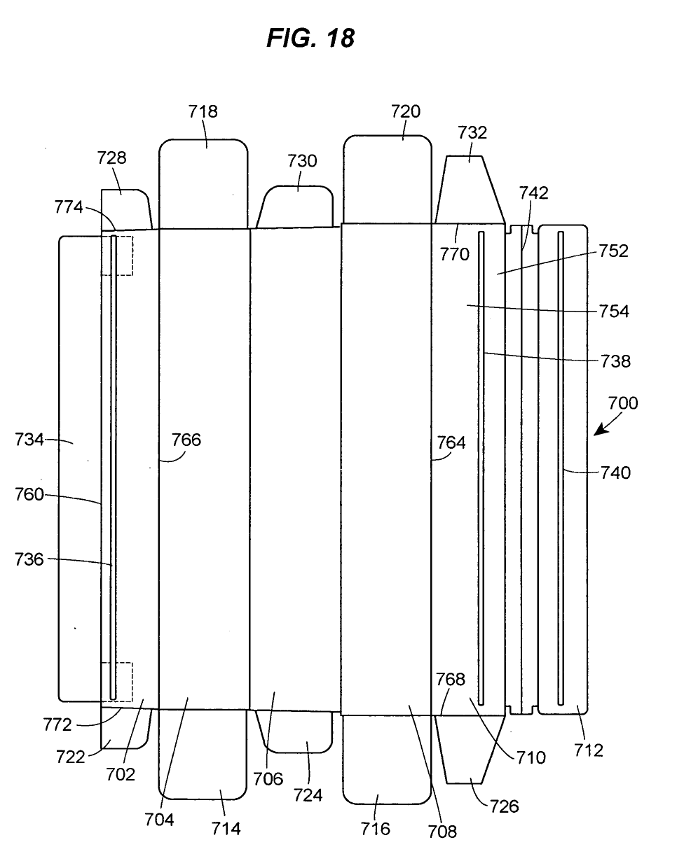

Referring next to FIG. 18, a box blank 700 according to yet another embodiment includes main sections 702, 704, 706, 708, 710, and 712, large end flaps 714, 716, 718, and 720, and small end flaps 722, 724, 726, 728, 730, and 732. The main sections and flaps are defined by score or fold lines as shown. The main section 702 includes a flap 734 and the main sections 702, 710, and 712 include slots 736, 738, and 740, respectively. The box blank 700 is oriented in the fashion shown in FIG. 18 with the printed side (which will eventually comprise the outside of the box) down.

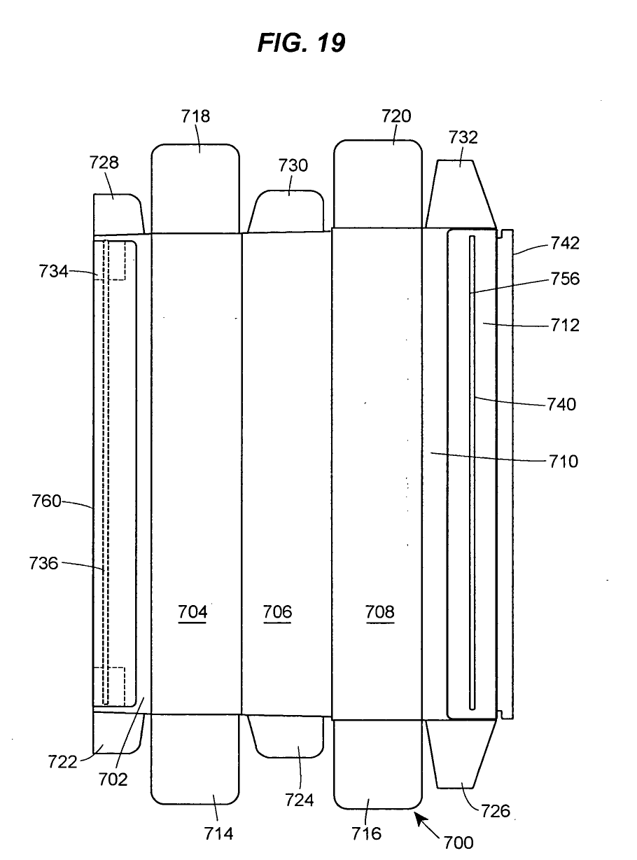

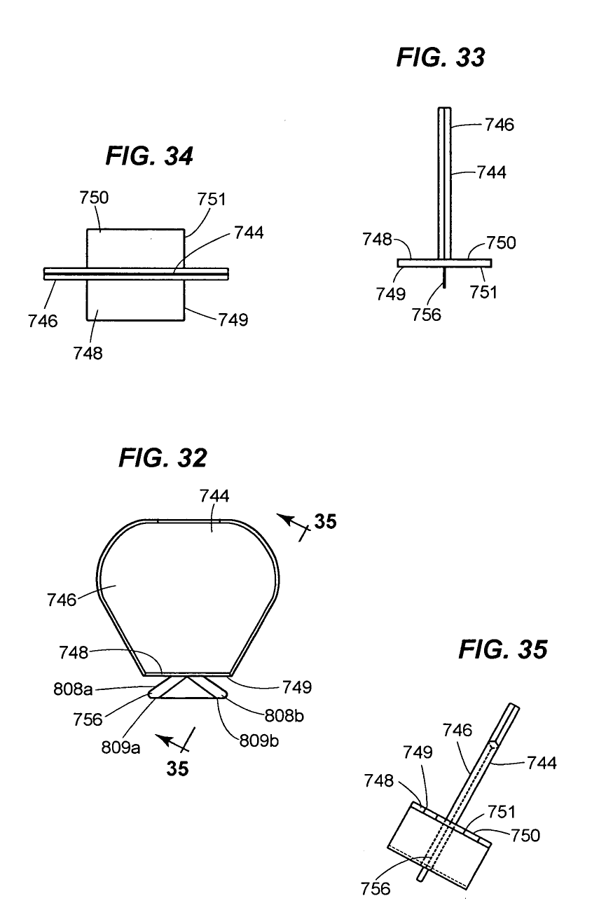

Referring also to FIG. 19, a first step in the erection of the blank 700 comprises folding of the main section 712 about a fold line 742. At this time the cutter 744 illustrated in FIGS. 32-36 may be assembled with the blank 700 by inserting a gripping portion 746 of the cutter 744 through the slot 738 until planar side surfaces 748, 750 of side members 749, 751, respectively, abut surfaces 752, 754 disposed on either side of the slot 738. The main section 712 is glued to the main section 710 at locations outside of the areas where the side members 749, 751 contact the surfaces 752, 754 so that the cutter 744 is captured between the main sections 710, 712, but is able to freely slide along the full length of the slots 738, 740. At this point a cutter blade 756 of the cutter 744 extends through the slot 740 while the gripping portion 746 extends outwardly through the slot 738.

Either before or after the preceding step, the flap 734 is folded about a fold line 760 (FIGS. 18 and 19) and glued to the remainder of the main section 702, thereby covering the slot 736.

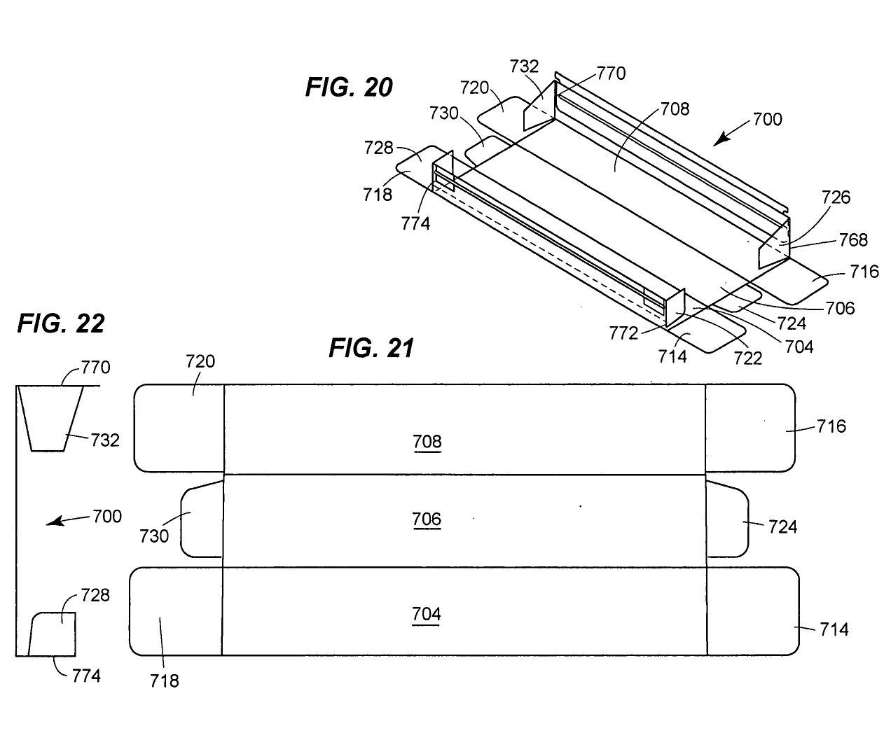

Referring next to FIGS. 20-22, the main section 710 and the main section 702 are folded 90 degrees upwardly about fold lines 764, 766, respectively. In addition, the flaps 726, 732 and 722, 728 are folded 90 degrees inwardly about fold lines 768, 770, 772, and 774, respectively.

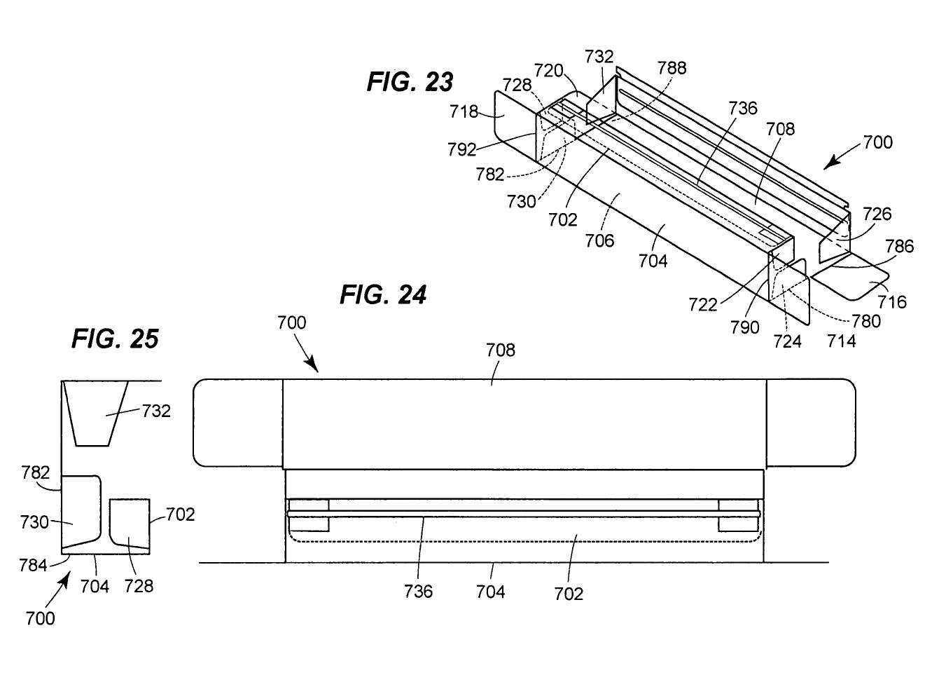

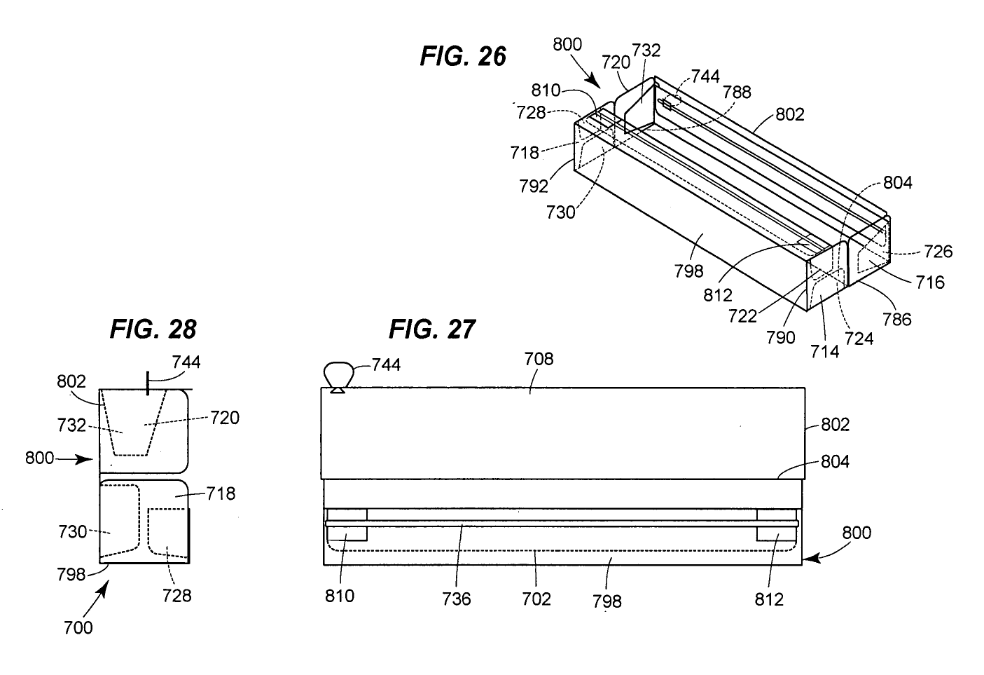

As seen in FIGS. 23-25 the next step in the erection procedure is to fold the flaps 724 and 730 upwardly 90 degrees about fold lines 780 and 782, respectively, and fold the main section 704 90 degrees upwardly about a fold line 784. As seen in FIGS. 26-28, the large flaps 716 and 720 are then folded 90 degrees upwardly about fold lines 786, 788 and are glued to the flaps 726, 732. Either before or after the foregoing step, the flaps 714, 718 are folded inwardly about fold lines 790, 792, respectively, and glued to the flaps 722, 724 and 728, 730, respectively.

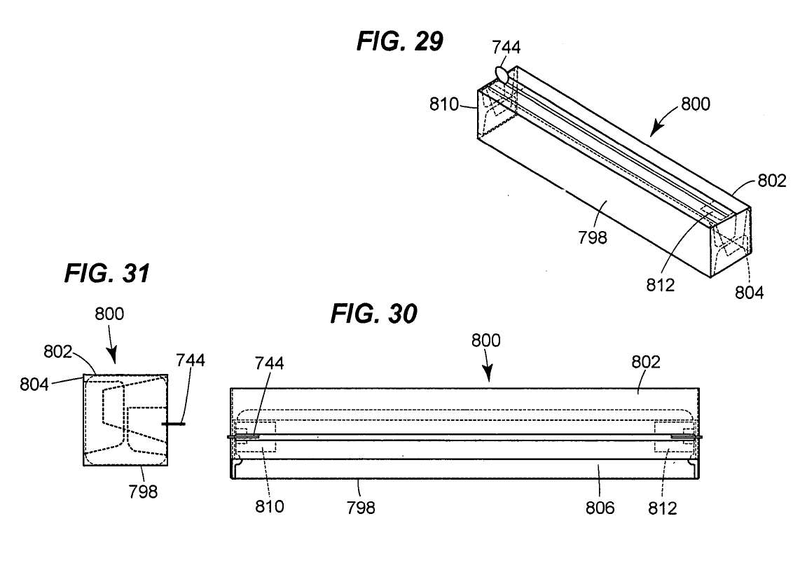

At this point, a roll of plastic cling film (not shown) is loaded into a lower portion 798 of the resulting box 800 defined by the main sections 702, 704, and 706. The film is wound on a cardboard core that is slightly longer than the width of the film and the slots 736, 738, and 740, are of sufficient length so that the cutter can traverse the full width of the film. A top portion 802 of the box 800 defined by the main sections 708, 710, and 712 is then folded 90 degrees about a fold line 804 (FIGS. 26-28, 29, and 31) into engagement with and covering the lower portion 798. An inside surface of a tear strip section 806 (FIG. 30) is glued to the outside surface of the lower portion 798 to complete the assembly process. At this point, the three slots 736, 738, and 740 are aligned and the blade 756 extends into the slot 736, but does not cut through the flap 734. The finished box is seen in FIGS. 29-31.

As should be evident, the foregoing steps may be undertaken in a different order, if desired.

As can be seen in FIG. 32, the blade 756 has two beveled and sharpened edges 808a, 808b having rounded tip portions 809a, 809b, respectively. The blade 756 can cut film in either of two directions, and the chances of a user inadvertently cutting himself or herself are minimized by the rounded tip portions 809a, 809b.

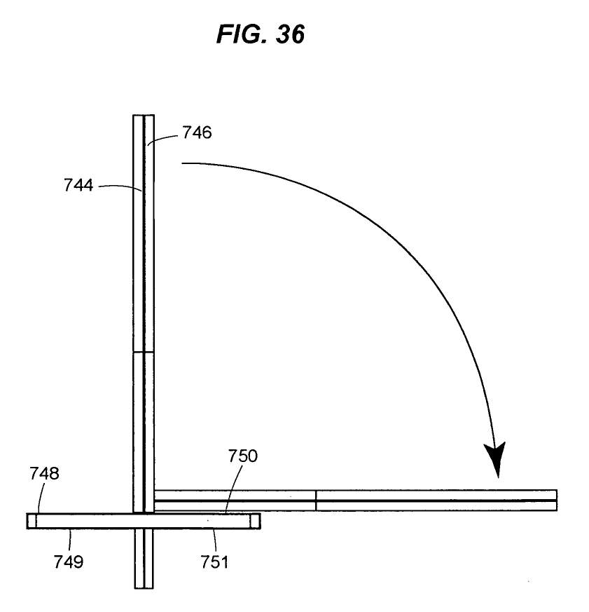

The lower portion 798 includes portions 810 and 812 (FIGS. 26, 27, 29, and 30) at opposite ends of the 736 that are coated with an adhesive, preferably of the low-tack variety. The finished box 800 is shown in FIGS. 29-31 ready for use. The gripping portion 746 of the cutter 744 is preferably made of cardboard, paperboard, or other flexible and inexpensive material so that the gripping portion 746 can be folded down in the manner shown in FIG. 36 during shipment of the box 800.

When the box 800 is to be opened and the film therein is to be dispensed, a user tears off the tear strip section 806 and lifts up the top portion 802. The user then pulls out a desired length of film and presses the film into contact with the adhesive-coated portions 810, 812 so that the film is held firmly in place. The user then ensures that the cutter 744 is disposed at one of the ends of the aligned slots 736, 738, 740 and closes the top portion 802 onto the lower portion 798. While firmly holding down the top portion 802, the user grasps the gripping portion 746 and slides the cutter to the opposite end of the aligned slots 736, 738, and 740 to cut the film. The user may then open the box and remove the cut film.

The cutter 744 has several important features. The blade 756 is designed to cut in both directions so that it does not matter which end of the box 800 the cutter is initially positioned. This versatility is accomplished by having both sides of the blade 756 taper toward the center of the blade 756 starting at the bottom thereof. Each of the angled sides has a double bevel to make the blade 756 sharp enough to cut the film and a rounded tip 809 to prevent the user from touching the blade and sustaining a cut. The cutter 744 is restrained between slots 738 and 740 in the top portion 802 of the box 800 by being held by the two side members 749, 751 that are perpendicular to the blade 756. The blade 756 extends out underneath the slot 740 and the gripping portion 746 of the cutter extends outwardly from the slot 738. The gripping portion 746 is designed to fold down as shown in FIG. 36 so that the gripping portion 746 lays flat against the outside of the box 800 when it is packaged.

As noted above, when the sections of the box containing slots 738 and 740 are glued together care is taken to avoid placing glue in an area where the side members 749, 751 contact as the cutter 744 is moved. This absence of glue is what allows the cutter 744 to freely slide from end to end of the slots 738 and 740, cutting any film placed underneath it. The slots 738 and 740 form a track that keeps the cutter 744 from falling out in two different ways. One way is by enclosing the ends of the track with the folded flaps and the other way is by ending the track just before the end of the box 800.

The slot 736, located on the bottom half of the box 800, lines up with the slots 738 and 740 when the dispenser is closed. The blade 756 ends up traveling in the channel created by the slot 736 and the layer of cardboard behind the slot 736. This channel elevates the film above the top of the blade 756 and when the film is trapped between the top and the bottom portions of the box 800 the blade 756 can cut the film. The cardboard behind the slot 736 prevents the blade 756 from damaging the unused film left inside the box. The adhesive coated portions 810, 812 on the top and bottom of both ends of the slot 736 give the film additional tension across the end area where the blade 756 is to begin cutting, which creates a smooth and easy cut.

The film roll contained in the dispenser is made up of a full-length cardboard core and the rolled film. The film does not come to the ends of the core, but rather is slightly recessed from the ends of the core so that the film is located on the inside of the location of the blade 756 at either end of the slots. This ensures that the slider blade 756 cuts the full length of the film.

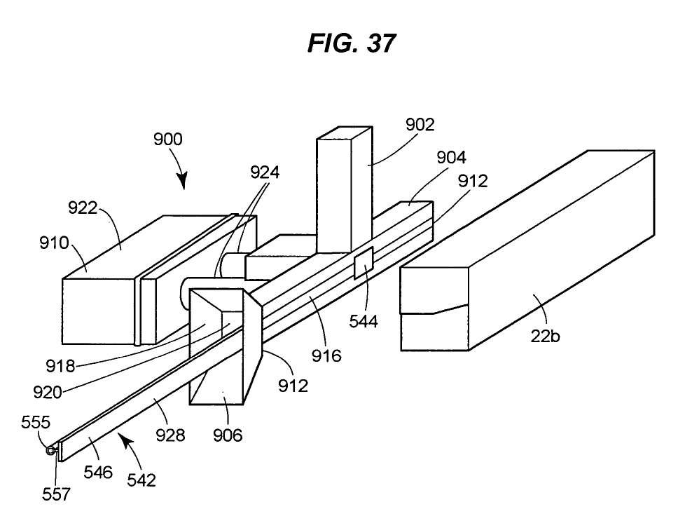

Referring now to FIGS. 37-39 a method of assembling a container 1032 that utilizes a cutting apparatus 524 similar to the mechanism shown in FIG. 13 but without the retaining lips and a box 22b identical to the box described in relation to FIG. 2c is described. An assembly apparatus 900 includes a slider tube 902, a track tube 904, a receiving funnel 906, a pneumatic ram 910 and a cutting mechanism (not shown). The slider tube 902 is preferably disposed in a vertical position in relation to the ground in order to receive a slider 544. The track tube 904 is preferably located perpendicular to the slider tube 902 and includes an opening (not shown) where the slider tube 902 is attached, preferably approximately in the middle of a length of the slider tube 902. The track tube 904 further includes a sealed end 912, an open end 914, and a slot 916. The slot 916 is disposed on a side of the track tube 904 perpendicular to the side attached to the slider tube 902, spans the length of the track tube 904 between the open end 914 and the sealed end 912, and is of size and dimension to allow the support rail 557 and circular top portion 555 of the track assembly 542 to pass through the slot 916 but not the track base 546. The receiving funnel 906 defines an entrance mouth 918 and an exit mouth 920 smaller than the entrance mouth 916 and of dimension and shape to match the open end 914 of the track tube 904. The pneumatic ram 910 includes a base 922 and a pair of pneumatic arms 924 connecting the base to the side of the track tube 904 opposite the slot 916. As the pneumatic arms extend from the base 922 they define a path 926.

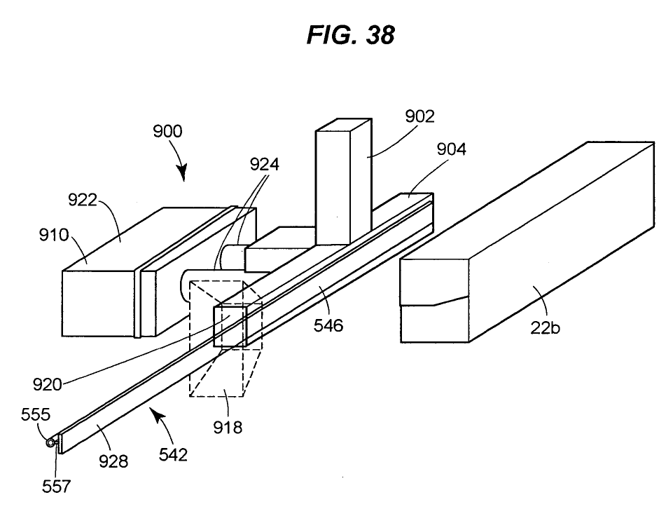

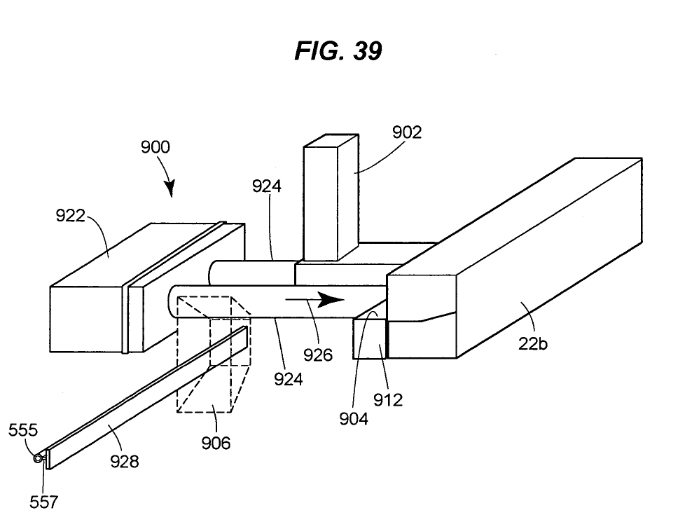

The first step of the method is shown in FIG. 37. A box 22b is brought into position so that the horizontal shelf 32b2 is parallel with the slot 916 and in the line of the path 926. When the box 22b is brought into position a glue or similar adhesive (not shown) has been pre-applied to the horizontal shelf 32b2. Simultaneously, a slider 544 falls down the slider tube 902 and comes to rest in the track tube 902. The slider 544 must be positioned so that the slot 592 of the slider 544 is parallel and adjacent to the slot 616 of the track tube 904. Next, shown in FIG. 38, a strip 928 of the track assembly 542 comes through the receiving funnel 906 and into the open end 914 of the track tube 904. The strip 928 must be positioned so that the support rail 557 is aligned to enter the slot 916 of the track tube 904 with the circular shaped top portion 555 on the inside of the track tube 904 and the track base 546 on the outside of the track tube 904. The strip 928 is slid into the track tube 904, threading through the opening of the slider 544 and continuing until the strip 928 contacts the sealed end 912 of the track tube 904. Third, the cutting mechanism cuts the strip 928 between the receiving funnel 906 and the track tube 904. Next, and shown in FIG. 39, the pneumatic ram 910 activates and the pneumatic arms 924, extending the track tube 904 until the track base 546 comes in contact with glue on the horizontal shelf 32b2. The cutting apparatus 524 is then bonded to the box 22b and the assembly apparatus 900 returns to the starting position. The process can then be repeated. Modifications of this method can be utilized with any cutting apparatus design to attach it to such a box 22b.

### INDUSTRIAL APPLICABILITY

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

1. A dispenser for sheet material, comprising:
a box; and
a cutting apparatus attached to the box, wherein the cutting apparatus includes a track assembly and a slider assembly disposed on the track assembly for movement therealong;
wherein the track assembly includes a base and a rail extending from an outer side of the base and terminating in a portion having an oval cross-sectional shape.

2. The dispenser of claim 1, wherein the cutting apparatus is attached to the first wall on the container section below the mouth.

3. The dispenser of claim 1, wherein the cutting apparatus is attached to a second wall opposite the lid section and adjacent an edge of the second wall that abuts the first wall.

4. The dispenser of claim 1, wherein the slider includes a base portion, a body portion, a head portion, a neck portion, and two blades.

5. The dispenser of claim 4, wherein the base portion of the slider assembly includes a slot adjacent an oval-shaped cavity that receive the rail and oval-shaped portion of the track assembly, respectively.

6. The dispenser of claim 5, wherein the slider assembly is pivotable and wherein the body portion, neck portion, and head portion of the slider assembly are integral with one another.

7. The dispenser of claim 1, wherein the track assembly further includes two L-shaped retaining lips located on each side of the base and extending from the outer side of the base.

8. The dispenser of claim 7, wherein the slider includes a base portion that defines a box shape with a slot through a side thereof and a channel through a center thereof so that the slot and channel may receive the rail and oval-shaped portion of the track assembly, respectively.

9. The dispenser of claim 8, wherein the slider further includes support members extending away from the rail on a bottom edge of the base portion to form an interference fit with the L-shaped retaining lips.

10. The dispenser of claim 9, wherein the slider further includes a neck portion connecting the base portion and a head portion and wherein the neck portion includes at least one blade extending parallel to a longitudinal extent of the track assembly.

11. The dispenser of claim 9, wherein the base of the track assembly further includes ribs extending from the outer side of the base and contacted by the slider assembly.

12. A dispenser for sheet material, comprising:
a box; and
a cutting apparatus attached to the box, wherein the cutting apparatus includes a track assembly and a slider assembly disposed on the track assembly for movement therealong;
wherein the track assembly includes a base and two support rails extending from an upper side of the base and terminating in circular-shaped portions and wherein the support rails are spaced from and parallel to one another and wherein the slider assembly is disposed between the support rails.

13. The dispenser of claim 12, wherein the slider assembly includes a bottom portion that contacts the upper side of the base and wherein the bottom portion is wider than a distance between the circular-shaped portions to retain the bottom portion of the slider assembly therein.

14. The dispenser of claim 13, wherein the slider assembly further includes a middle portion connecting the bottom portion and a top portion and wherein the middle portion has a width that is less than the distance between the circular-shaped portions.

15. The dispenser of claim 14, wherein the middle portion of the slider assembly includes a blade extending from the middle portion extending parallel to a longitudinal extend of the track assembly.

16. The dispenser of claim 15, wherein the base of the track assembly further includes a retaining rail extending upwardly from the upper surface of the base and disposed between the rails and wherein the retaining rail terminates in an arrow-shaped portion.

17. The dispenser of claim 16, wherein the slider assembly includes an arrow-shaped notch that cooperates with the arrow-shaped portion of the retaining rail to maintain the slider assembly between the support rails.

18. The dispenser of claim 12, wherein the slider assembly includes a base portion having an inner portion and two outer portions that encircle the support rails.

19. The dispenser of claim 18, wherein the slider assembly further includes a blade mounted in the base portion and extending between and parallel to the support rails.

20. A dispenser for sheet material, comprising:
a box having an angled corner; and
a cutting apparatus disposed on the angled corner of the box and including a slider assembly.

21. The dispenser of claim 20, wherein the cutting apparatus includes a track assembly attached to the surface of the angled corner and a sliding apparatus disposed on the track assembly for movement therealong.

22. The dispenser of claim 20, wherein the angled corner includes a slot formed in a surface thereof along a length of the box.

23. The dispenser of claim 22, wherein the slider assembly includes a base portion disposed inside the box, a neck portion disposed in the slot, and a head portion disposed outside of the box, wherein the base portion, neck portion, and head portion are integral with one another and the neck portion includes a blade extending from a side thereof extending parallel to a longitudinal extend of the slot.

24. The dispenser of claim 23, wherein portions of the surfaces of the angled corner adjacent the slot are reinforced with plastic.
